(19) United States
(12) Patent Application Publication
(10) Pub. No.: US 2007/0020491 A1
(43) Pub. Date: Jan. 25, 2007

(54) Stoichiometric control methodology for fuel cell systems

(76) Inventor: Michael Ogburn, Blacksburg, VA (US)

Correspondence Address: TUNG & ASSOCIATES, 838 WEST LONG LAKE, SUITE 120, BLOOMFIELD HILLS, MI, 48302, US

(21) Appl. No.: 11/187,272

(22) Filed: Jul. 21, 2005

(51) Int. Cl. H01M 8/04

(52) U.S. Cl. 429/13; 429/23

(57) ABSTRACT

A method of restoring a low cell voltage of a fuel cell in a fuel cell system to a normal cell voltage without reducing a total power output level of the fuel cell system is disclosed. The method includes operating the fuel cell system at a selected total power output level, monitoring a cell voltage of the fuel cell, detecting a low cell voltage of the fuel cell, maintaining the selected total power output level of the fuel cell system and restoring the fuel cell from the low cell voltage to the normal cell voltage by increasing flow of a gas to the fuel cell from a baseline stoichiometry to an elevated stoichiometry.

### FIELD OF THE INVENTION

The present invention relates to fuel cells which are suitable for generating electricity for automotive or other applications. More particularly, the present invention relates to a stoichiometric control methodology which includes increasing the flow of reactant gases to a low-voltage fuel cell or cells in a fuel cell stack in order to recover the cell or cells without reducing overall power output from the stack.

### BACKGROUND OF THE INVENTION

In recent years, much research has been devoted to the development of fuel cell systems to generate energy for automotive and other applications. A fuel cell system produces electricity by harvesting electrons from hydrogen gas. Oxygen is reduced by the harvested electrons and combined with protons to produce water as a by-product. Fuel cell vehicles are highly efficient and environmentally-friendly.

A typical conventional fuel cell system includes multiple fuel cells, each of which includes an electrolyte membrane interposed between an anode catalyst layer and a cathode catalyst layer to form a membrane electrode assembly (MEA). A gas diffusion medium (GDM) layer engages each catalyst layer, and a bipolar plate engages each GDM layer. The anode side bipolar plate is provided with flowfield channels which distribute a reactant gas, which contains hydrogen gas or may be pure hydrogen gas, to the anode catalyst layer through the anode side GDM layer. The cathode side bipolar plate is likewise provided with flowfield channels which distribute an oxidant gas, which contains oxygen or may be pure oxygen, to and reactant water vapor away from the cathode catalyst layer through the cathode side GDM layer.

During operation of the fuel cell system, hydrogen gas is split into electrons and protons at the anode catalyst layer. The protons are passed from the anode catalyst layer, through the electrolyte membrane and to the cathode catalyst layer. The electrons are distributed as electrical current from the anode catalyst layer, through an external circuit to drive an electric motor, and then to the cathode catalyst layer. At the cathode catalyst layer, molecular oxygen is split into oxygen atoms, which combine with the electrons and protons to form water. The water is distributed from the fuel cell system through the flowfield plates of the cathode side bipolar plate. In the fuel cell system, multiple individual fuel cells are stacked in series to form a fuel cell stack in which voltages and quantities of electricity proportional to the number of fuel cells are generated.

For a fuel cell system, reactant stoichiometry is defined as the ratio of the quantity of reactant gas supplied to the quantity of reactant gas required for the fuel cell system to produce electrical current at a given level of total power output. Oxidant stoichiometry is defined as the ratio of the quantity of oxidant gas supplied to the quantity of oxidant gas consumed by a fuel cell system producing a given level of total power output. If the oxidant gas is a dilute oxidant stream such as air, only the reactant component (oxygen) is considered in the calculation of stoichiometry. Therefore, oxygen stoichiometry would be the ratio of the quantity of oxygen supplied to the cathode to the quantity of oxygen required to produce the given level of total power output.

During operation, fuel cell systems periodically experience internal operational events that require the total power output of the system to be temporarily reduced until the operational event is over. During this time, the power-consuming device (such as a fuel cell vehicle, for example) which is fed by the fuel cell system is unable to receive the full quantity of power that is required by the device. As an example, a fuel cell system may normally operate at a given fraction of maximum total power output capacity (such as 50% of maximum output capacity, for example). If during the operation of the fuel cell system a “low cell voltage” signal is detected on one or more of the numerous fuel cells within the fuel cell system, the system reduces its total power output (such as to 25% of maximum output capacity, for example) and attempts to recover the normal cell voltage of the fuel cell. It does this by increasing the gas flow (stoichiometry) to the fuel cell to a level which is slightly above that which would normally be required at the reduced total power output of 25%. Once the voltage of the fuel cell or cells is/are restored, the fuel cell system attempts to return to the requested total power output level of 50%. However, it is desired to maintain a constant total power output level during operation of the fuel cell.

Accordingly, a novel method is needed to recover a reduced voltage of a fuel cell without reducing the total power output of a fuel cell system.

### SUMMARY OF THE INVENTION

The present invention is generally directed to a novel stoichiometric control method for restoring the low voltage of a fuel cell or cells in a fuel cell system to a normal voltage level without reducing the total power output level of the fuel cell system. The method includes operating the fuel cell system at a given total power output level, monitoring the voltages of individual fuel cells in the system, detecting a low cell voltage in at least one of the fuel cells, maintaining the total power output level of the fuel cell system, and increasing a gas flow stoichiometry to the fuel cell or cells to recover the normal voltage level of the fuel cell or cells.

### BRIEF DESCRIPTION OF THE DRAWINGS

The invention will now be described, by way of example, with reference to the accompanying drawing, in which:

FIG. 1 is a schematic of a fuel cell system in implementation of the method of the present invention; and

FIG. 2 is a flow diagram which illustrates sequential process steps carried out according to the method of the present invention.

### DETAILED DESCRIPTION OF THE INVENTION

According to the method of the present invention, a novel stoichiometric control method is used to restore a normal cell voltage of a fuel cell or cells, having been detected with a low cell voltage, to a normal cell voltage in a fuel cell system without reducing the total power output level of the fuel cell system. The method includes operating the fuel cell system at a selected total power output level, at which level fuel gas and oxidant gas are delivered to a fuel cell stack at a baseline gas flow stoichiometry. The cell voltages of the individual fuel cells in the fuel cell system are monitored. If a low cell voltage is detected in at least one of the fuel cells, the selected total power output level of the fuel cell system is maintained, and simultaneously, the fuel gas and/or oxidant gas is/are delivered to the fuel cell stack at a stoichiometry which is greater than the baseline stoichiometry in order to recover the normal cell voltage level of the fuel cell or cells. After the normal cell voltage level of the fuel cell or cells has been recovered, the fuel gas stoichiometry and/or the oxidant gas stoichiometry is/are reduced back to the baseline stoichiometry.

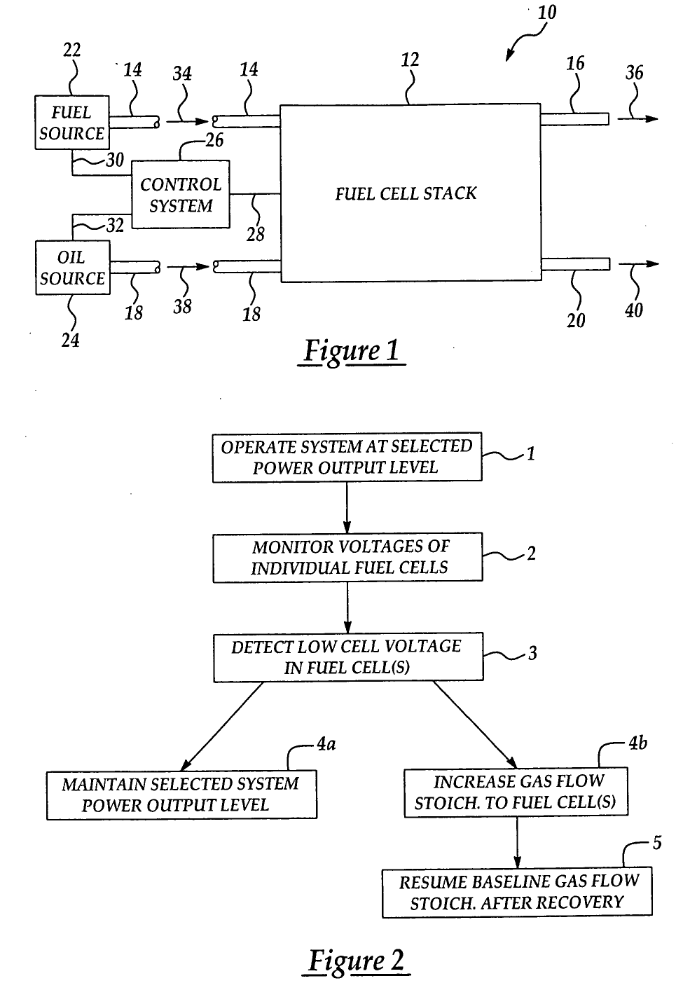

A schematic view of a fuel cell system in implementation of the present invention is generally indicated by reference numeral 10 in FIG. 1. The fuel cell system 10, which may be conventional, may be implemented in a fuel cell vehicle (not shown) or in any other application in which electrical power is required. The fuel cell system 10 generally includes a fuel cell stack 12 having multiple, stacked fuel cells (not shown). A fuel inlet conduit 14 connects a fuel source 22 to the fuel cell stack 12, and an oxidant inlet conduit 18 connects an oxidant source 24 to the fuel cell stack 12. Accordingly, the fuel inlet conduit 14 is adapted to distribute a fuel gas 34 from the fuel source 22 to the fuel cell stack 12, whereas the oxidant inlet conduit 18 is adapted to distribute an oxidant gas 38 from the oxidant source 24 to the fuel cell stack 12. A fuel exhaust outlet 16 extends from the fuel cell stack 12 for distributing fuel exhaust 36 from the fuel cell stack 12, and an oxidant exhaust outlet 20 extends from the fuel cell stack 12 for distributing oxidant exhaust 40 from the fuel cell stack 12. Each of the fuel source 22 and the oxidant source 24 typically includes a gas delivery subsystem (not shown) having a mechanical device such as a compressor, fan, pump, rotary piston blower or equivalent mechanical device that forces the fuel gas 34 through the fuel inlet conduit 14 and the oxidant gas 38 through the oxidant inlet conduit 18, respectively.

A control system 26 is operably connected to the fuel cell stack 12 typically by suitable stack wiring 28. The control system 26 is also connected to the fuel source 22 typically by fuel source wiring 30 and to the oxidant source 24 typically by oxidant source wiring 32. Accordingly, the control system 26 is designed to both control the total power output level of the fuel cell stack 12 and monitor the cell voltages of individual fuel cells in the fuel cell stack 12. The control system 26 also controls the reactant stoichiometry of fuel gas 34 distributed from the fuel source 22 to the fuel cell stack 12 and the oxidant stoichiometry of oxidant gas 38 distributed from the oxidant source 24 to the fuel cell stack 12.

As used herein, “reactant stoichiometry” is defined as the ratio of the quantity of fuel gas 34 which is supplied by the fuel source 22 to the quantity of fuel gas 34 which is required by the fuel cell stack 12 for the fuel cell system 10 to produce electrical current at a selected level of total power output. The fuel gas 34 typically includes hydrogen and may be pure gaseous hydrogen or a dilute hydrogen stream such as a reformate stream, for example. Alternatively, the fuel gas 34 may include methanol, dimethyl ether or any other suitable gas which may be directly oxidized by the anode catalyst layer in the individual fuel cells of the fuel cell stack 12. If the fuel gas 34 is a dilute hydrogen stream, only the reactant component (hydrogen) is considered in the calculation of reactant stoichiometry. Therefore, in that case, hydrogen stoichiometry would be the ratio of the quantity of hydrogen which is supplied by the fuel source 22 to the fuel cell stack 12 to the quantity of hydrogen which is required by the fuel cell stack 12 to produce the selected level of total power output.

As used herein, “oxidant stoichiometry” is defined as the ratio of the quantity of oxidant gas 38 which is supplied by the oxidant source 24 to the quantity of oxidant gas 38 which is consumed by the fuel cell stack 12 for the fuel cell system 10 to produce the selected level of total power output. The oxidant gas 38 typically comprises oxygen and may be pure gaseous oxygen or a dilute oxygen stream such as air. If the oxidant gas 38 is a dilute oxygen stream such as air, only the reactant component (oxygen) is considered in the calculation of oxidant stoichiometry. Therefore, in that case, oxygen stoichiometry would be the ratio of the quantity of oxygen which is supplied by the oxidant source 24 to the fuel cell stack 12 to the quantity of oxygen which is required by the fuel cell system 10 to produce the selected level of total power output.

In operation of the fuel cell system 10 according to the method of the present invention, the control system 26 operates the fuel cell stack 12 at a selected total power output level, such as, for example, 50% of the maximum power output. Such a selected total power output level provides sustained electrical power for operation of a fuel cell vehicle or other application. Simultaneously, the control system 26 causes the fuel source 22 to distribute fuel gas 34 through the fuel inlet conduit 14 and into the fuel cell stack 12 and the oxidant source 24 to distribute oxidant gas 38 through the oxidant inlet conduit 18 and into the fuel cell stack 12.

The fuel gas 34 and oxidant gas 38 are delivered to the fuel cell stack 12 at a baseline reactant stoichiometry and baseline oxidant stoichiometry, respectively, to sustain the selected total power output level of the fuel cell system 10. The baseline reactant stoichiometry and baseline oxidant stoichiometry will vary according to the particular type of fuel cell system 10, as well as the level of the selected total power output of the fuel cell stack 12. However, a surplus of fuel gas 34 is typically delivered to the fuel cell stack 12 to provide more hydrogen gas than is needed to sustain operation of the fuel cell stack 12 at the selected total power output level. Likewise, a surplus of oxidant gas 38 is typically delivered to the fuel cell stack 12 to prevent oxidant starvation of the fuel cells in the fuel cell stack 12. Oxygen starvation is the condition wherein the oxidant stoichiometry is less than one. A typical baseline reactant stoichiometry and baseline oxidant stoichiometry to sustain operation of the fuel cell stack 12 at the selected total power output level is typically at least about 2.0.

In the fuel cell stack 12, the individual fuel cells generate electrical power by harvesting electrons from the hydrogen in the fuel gas 34; passing the electrons as electrical current to an external circuit, which powers an electric motor; splitting molecular oxygen in the oxidant gas 38 into oxygen atoms; and combining protons from the oxidized hydrogen with the electrons and oxygen atoms to form water. Excess fuel gas 34 is discharged as fuel exhaust 36 from the fuel cell stack 12 through the fuel exhaust outlet 16. Exhaust water is discharged as oxidant exhaust 40 from the fuel cell stack 12 through the oxidant exhaust outlet 20.

Throughout operation of the fuel cell system 10, the control system 26 constantly monitors the cell voltages of the individual fuel cells contained in the fuel cell stack 12. In the event that the control system 26 detects a low cell voltage in one or more of the fuel cells in the fuel cell stack 12, the control system 26 maintains operation of the fuel cell stack 12 at the selected total power output level (50% of the maximum power output in this case). Simultaneously, the control system 26 causes the fuel source 22 to increase the reactant stoichiometry of the fuel gas 34 from the baseline reactant stoichiometry to an elevated reactant stoichiometry (such as from about 2.0 to at least about 3.0, for example) by increasing the rate of distribution of the fuel gas 34 into the fuel cell stack 12. The control system 26 typically also causes the oxidant source 24 to increase the oxidant stoichiometry of the oxidant gas 38 from the baseline oxidant stoichiometry to an elevated oxidant stoichiometry (such as from about 2.0 to at least about 3.0, for example) by increasing the rate of distribution of the oxidant gas 38 into the fuel cell stack 12. These actions facilitate the distribution of additional hydrogen and oxygen to the low-voltage fuel cell or cells, thereby restoring the fuel cell or cells to the normal cell voltage by enabling the fuel cell or cells to generate additional electrical current. When the control system 26 detects that the cell voltage of the fuel cell or cells has been restored to the normal cell voltage, the control system 26 causes the fuel source 22 to again deliver the fuel gas 34 to the fuel cell stack 12 and the oxidant source 24 to again deliver the oxidant gas 38 to the fuel cell stack 12 at the baseline reactant and oxidant stoichiometries, respectively, necessary to sustain the fuel cell stack 12 at the selected total power output level.

When the low cell voltage is detected in the fuel cell or cells in the fuel cell stack 12, the control system 26 typically increases both the reactant stoichiometry and the oxidant stoichiometry to the elevated stoichiometry levels in order to restore the normal cell voltage level of the fuel cell or cells, as heretofore described. However, it is understood that the method of the present invention may include increasing either the reactant stoichiometry or the exhaust stoichiometry to the elevated stoichiometry level in order to restore the normal cell voltage level of the fuel cell or cells without decreasing the selected total power output of the fuel cell stack 12.

A stoichiometric control method according to the present invention is shown in the form of a flow diagram in FIG. 2. In step 1, a fuel cell system is operated at a selected total power output level. In step 2, the cell voltage of each individual fuel cell is monitored throughout operation of the fuel cell system. In step 3, a low cell voltage may be detected in one or more of the fuel cells of the fuel cell system. Consequently, the total power output level of the fuel cell system is maintained at the same level, as indicated in step 4a, as the gas flow stoichiometry to the fuel cells is increased, as indicated in step 4b. This may include increasing the reactant stoichiometry, the oxidant stoichiometry, or both the reactant and oxidant stoichiometries to an elevated stoichiometry level. After the cell voltage of the fuel cell or cells has been restored, the gas flow stroichiometry is reduced from the elevated stoichiometry to the baseline gas flow stoichiometry, as indicated in step 5, to maintain the fuel cell system at the selected total power output level.

It is to be understood that the invention is not limited to the exact construction and method which has been previously delineated, but that various changes and modifications may be made without departing from the spirit and scope of the invention as delineated in the following claims.

What is claimed is:

1. A method of restoring a low cell voltage of a fuel cell in a fuel cell system to a normal cell voltage without reducing a total power output level of the fuel cell system, comprising:
operating said fuel cell system at a selected total power output level;
distributing a gas to said fuel cell at a baseline stoichiometry;
detecting a low cell voltage of said fuel cell;
maintaining said selected total power output level of said fuel cell system; and
restoring said fuel cell from said low cell voltage to said normal cell voltage by increasing flow of said gas to said fuel cell from said baseline stoichiometry to an elevated stoichiometry.

2. The method of claim 1 wherein said increasing flow of said gas to said fuel cell from said baseline stoichiometry to an elevated stoichiometry comprises increasing flow of a fuel gas from a baseline reactant stoichiometry to an elevated reactant stoichiometry.

3. The method of claim 2 wherein said baseline reactant stoichiometry is at least about 2.0 and said elevated reactant stoichiometry is at least about 3.0.

4. The method of claim 1 wherein said increasing flow of said gas to said fuel cell from said baseline stoichiometry to an elevated stoichiometry comprises increasing flow of an oxidant gas from a baseline oxidant stoichiometry to an elevated oxidant stoichiometry.

5. The method of claim 4 wherein said baseline oxidant stoichiometry is at least about 2.0 and said elevated oxidant stoichiometry is at least about 3.0.

6. The method of claim 1 wherein said increasing flow of said gas to said fuel cell from said baseline stoichiometry to an elevated stoichiometry comprises increasing flow of a fuel gas from a baseline reactant stoichiometry to an elevated reactant stoichiometry and increasing flow of an oxidant gas from a baseline oxidant stoichiometry to an elevated oxidant stoichiometry.

7. The method of claim 6 wherein said baseline reactant stoichiometry is at least about 2.0 and said elevated reactant stoichiometry is at least about 3.0, and wherein said baseline oxidant stoichiometry is at least about 2.0 and said elevated oxidant stoichiometry is at least about 3.0.

8. The method of claim 1 wherein said total power output level is about 50% of a maximum power output level.

9. A method of restoring a low cell voltage of at least one fuel cell in a fuel cell stack of a fuel cell system to a normal cell voltage without reducing a total power output level of the fuel cell system, comprising:
operating said fuel cell system at a selected total power output level;
distributing a fuel gas and an oxidant gas into said fuel cell stack at a baseline stoichiometry;
monitoring cell voltages of a plurality of fuel cells in said fuel cell stack;
detecting a low cell voltage of at least one of said fuel cells;
maintaining said selected total power output level of said fuel cell system; and
restoring said at least one of said fuel cells from said low cell voltage to said normal cell voltage by increasing flow of at least one of said fuel gas and said oxidant gas into said fuel cell stack from said baseline stoichiometry to an elevated stoichiometry.

10. The method of claim 9 wherein said increasing flow of at least one of said fuel gas and said oxidant gas into said fuel cell stack from said baseline stoichiometry to an elevated stoichiometry comprises increasing flow of said fuel gas into said fuel cell stack from a baseline reactant stoichiometry to an elevated reactant stoichiometry.

11. The method of claim 10 wherein said baseline reactant stoichiometry is at least about 2.0 and said elevated reactant stoichiometry is at least about 3.0.

12. The method of claim 9 wherein said increasing flow of at least one of said fuel gas and said oxidant gas into said fuel cell stack from said baseline stoichiometry to an elevated stoichiometry comprises increasing flow of said oxidant gas into said fuel cell stack from a baseline oxidant stoichiometry to an elevated oxidant stoichiometry.

13. The method of claim 12 wherein said baseline oxidant stoichiometry is at least about 2.0 and said elevated oxidant stoichiometry is at least about 3.0.

14. The method of claim 9 wherein said fuel gas comprises pure gaseous hydrogen.

15. The method of claim 9 wherein said fuel gas comprises a dilute hydrogen stream.

16. The method of claim 9 wherein said oxidant gas comprises pure gaseous oxygen.

17. The method of claim 9 wherein said oxidant gas comprises a dilute oxygen stream.

18. A method of restoring a low cell voltage of at least one fuel cell in a fuel cell stack of a fuel cell system to a normal cell voltage without reducing a total power output level of the fuel cell system, comprising:
operating said fuel cell system at a selected total power output level;
distributing a fuel gas and an oxidant gas into said fuel cell stack;
monitoring cell voltages of a plurality of fuel cells in said fuel cell stack;
detecting a low cell voltage of at least one of said fuel cells;
maintaining said selected total power output level of said fuel cell system; and
restoring said at least one of said fuel cells from said low cell voltage to said normal cell voltage by increasing flow of said fuel gas into said fuel cell stack from a baseline reactant stoichiometry to an elevated reactant stoichiometry and increasing flow of said oxidant gas into said fuel cell stack from a baseline oxidant stoichiometry to an elevated oxidant stoichiometry.

19. The method of claim 18 wherein said baseline reactant stoichiometry is at least about 2.0 and said elevated reactant stoichiometry is at least about 3.0.

20. The method of claim 18 wherein said baseline oxidant stoichiometry is at least about 2.0 and said elevated oxidant stoichiometry is at least about 3.0.

21. The method of claim 18 wherein said fuel gas comprises pure gaseous hydrogen.

22. The method of claim 18 wherein said fuel gas comprises a dilute hydrogen stream.

23. The method of claim 18 wherein said oxidant gas comprises pure gaseous oxygen.

24. The method of claim 18 wherein said oxidant gas comprises a dilute oxygen stream.
